(19) United States
(12) Patent Application Publication
(10) Pub. No.: US 2011/0137944 A1
(43) Pub. Date: Jun. 9, 2011

(54) METHOD AND SYSTEM FOR MATCHING BETWEEN A TISSUE DONOR AND A TISSUE RECIPIENT

(75) Inventor: Dan Rolls, Rehovot (IL)

(73) Assignee: FAMILLION LTD., Tortola (VG)

(21) Appl. No.: 13/058,428

(22) PCT Filed: Aug. 11, 2009
(86) PCT No.: PCT/IL2009/000785

§ 371 Date: Feb. 10, 2011

Related U.S. Application Data
(60) Provisional application No. 61/136,056, filed on Aug. 11, 2008.

(51) Int. Cl. G06F 17/30

(52) U.S. Cl. 707/780; 707/E17.014

(57) ABSTRACT

A system and method are presented for identifying a suitable tissue donor for an intended tissue recipient. A database of individuals is provided that comprises, for each individual, genetic data parameters comprising hereditary parameters that play a role in tissue-typing for matching between donor and recipient and comprises genealogical data for a plurality of individuals including at least some of said individuals for whom the genetic data is provided in the database. A recipient tissue type (RTT) is determined for the intended tissue recipient. The database is searched for one or more individuals that have a degree of similarity to the RTT that satisfy predetermined criteria to thereby identify one or more pivot individuals. A search is conducted for a target group of target individuals that includes the pivot individuals and individuals that are genetically related to the pivot individuals, and output data indicative of search results is generated.

### FIELD OF THE INVENTION

The invention is generally in the field of human healthcare and concerns a method and system for finding a potential donor for a candidate tissue recipient.

### BACKGROUND OF THE INVENTION

Finding a matching donor for a recipient in need is a significant challenge. While tissue databanks exist, it is virtually impossible for them to cover the full range of human genetic diversity. And indeed, it is often very difficult to find a matching donor for a needing tissue recipient.

Bone marrow transplantation (BMT) is a widely acceptable medical procedure for a variety of serious health conditions. BMT has been used to treat patients diagnosed with leukemia, aplastic anemia, lymphomas such as Hodgkin's disease, multiple myeloma, immune deficiency disorders and some solid tumors such as breast and ovarian cancer. The use of BMT, notwithstanding the significant therapeutic potential, is limited in view of its complications and in particular the life-threatening graft-versus-host-diseases (GVHD) where functional immune cells in the transplanted bone marrow attack the host. Thus, while precise and accurate matching of donor-recipient is critical in any tissue or organ grafting, it is particularly critical in the case of grafting of bone marrow.

A successful transplant requires close tissue-type matching, in particular identity or near identity in the MHC antigens between the donor and the recipient. However, where no suitable donor is found among siblings of a transplant candidate, it is generally very difficult to find a donor with close tissue-type match.

### GENERAL DESCRIPTION

The present invention provides a computerized method and system for finding a potential donor for a tissue transplant candidate. In accordance with the invention, genealogical data is combined with genetic data of individuals for a targeted or better focused search for a suitable tissue donor.

Genealogical data includes some identifying data on individuals such as name, gender, birth date, etc, as well data on family ties to other individuals. Genealogical data may be provided or presented in the form of a family tree. The term “family tree” should be construed in a broad sense as relating to a data arrangement relating to a plurality of individuals and the family relationship between the individuals. A family tree may be represented graphically in many different ways; it may be data records stored in a computer-readable medium, etc. A family tree may also be thought of as a graph (which may be graphically represented or be a virtual representation within a computer) in which connecting lines (or their virtual equivalent) represent the family relationship and the nodes represent individuals in the family tree. The term “family tree” should thus be expansively construed to include any model for organizing one or more data repositories of hierarchical arrangement of genealogical data. A family tree may have various complexities: it may be as simple as one parent and one child and as complex as a single family tree that is formed through mergers of all family trees. A family tree may be constructed in a manner described, for example, in co-owned PCT applications, having the publication numbers WO 2007/083313 and WO 2008/053493, the content of which is incorporated herein by reference.

There are many molecular biology and other tools that allow the generation of genetic-related information on individuals relatively easily and inexpensively. This genetic information may include genomic data as well as antigenic data (such as information on the individual's MHC (major histocompatability complex antigens, which are critical for tissue matching). The term “genetic data” will be used herein to refer to any parameter relating to an individual that is hereditary in nature. These include data on specific genes, gene clusters, gene sequences or data on antigens found in or on cells of an individual. An illustrative, non-limiting example, is data concerning the major MHC, which is of prime importance in tissue-type matching for bone marrow transplantation. The term “genetic data parameters” will be used to refer to a selected list of types of genetic data that is used for tissue-type matching within the framework of the method and system for finding a potential donor for a candidate recipient. The genetic data parameters are, thus, hereditary parameters that play a role in tissue-typing for matching between donor and recipient.

The term “tissue type” refers to a combination of antigenic parameters that are searched in order to find a suitable donor, who has to have a matching tissue type to that of the recipient.

In accordance with the invention, a combined database is constructed that includes genealogical data as well as genetic data for at least some of the individuals that are included in the database. A search may then be instituted for individuals with genetic data parameters that show a relatively high degree of similarity with the corresponding genetic data parameters of the transplantation candidate. By some embodiments, a threshold or a minimum similarity may be defined that would qualify an individual as a “pivot individual” for a targeted search for a suitable donor. For example, where the genetic data parameters are MHC antigens, a certain number of identical MHC antigens may then qualify an individual as a pivot individual. Also, at times the pivot individuals may be defined as such based on genetic and/or bioinformatic considerations that predict a relatively high probability of finding a tissue donor match among individuals that are genetically related to such pivot individuals. Generally, the pivot individuals define a domain of target individuals that are genetically related to the pivot individuals and among which there is a higher probability of finding a match than among the general population.

The term “pivot individual” is used to denote one of a group of individuals for whom genetic data exists and that defines a group of target individuals. The pivot individuals are typically individuals that have genetic data parameters that have a degree of similarity to the corresponding genetic data parameters of the transplantation candidate above a defined threshold. However, they may also be individuals that define a group of target individuals related thereto that are determined to be such through statistical or computational considerations (e.g. genetic or bioinformatic considerations).

In some cases, one of the pivot individuals may be a suitable donor. However, where a suitable donor is not found among the pivot individuals, a further focused search may be instituted among target individuals that include siblings and other genetically-related individuals (parents, children, siblings and other individuals with a common ancestor, etc.), determined on the basis of the genealogical database.

The term “target individuals” is used herein to denote the individuals that are genetically related to the pivot individuals and are determined to be individuals that have a higher probability of being a suitable donor as compared to the general population. The target individuals are typically individuals for whom no genetic data is readily available or such for whom insufficient data exists. The target individuals may be defined based on Mandelian hereditary and other genetic considerations, on correlation between different inherited traits, etc. For example, based on known genetic considerations, once a certain individual is determined to be a pivot individual, a sibling or another genetically related individual may be defined as a target individual since the chance of such a target individual to be a suitable donor are considerably greater than an individual randomly selected from the general population. As another example, where two or more genetically related individuals are defined as pivot individuals, a whole domain of individuals including first (parent or children), second (siblings, grandparents, grandchildren, parents' siblings), third degree (grandparent siblings, cousins, etc.) and further degree relations may be defined as target individuals.

A suitable donor has a much higher likelihood of being found among the target individuals than among the general population. In some cases, the genetic data parameters for the target individuals may be available and may need to be imported from another database, or the target individuals may be asked to provide the data. In other cases, the next step would involve laboratory examination of the target individuals to obtain their relevant genetic data parameters.

According to current medical practice, a search for a donor outside the tissue databank requires, at times, actual screening of thousands and tens of thousands of individuals. In accordance with the invention, a campaign to find a matching donor is focused on the pivot individuals and their genetic relatives. Thus, in accordance with the invention, the search strategy for finding a suitable tissue donor, hones-in on a smaller, defined population of individuals with a higher probability of including a suitable donor among them.

The invention provides, according to one of its aspects, a method for identifying a suitable tissue donor for an intended tissue recipient. The method comprises:

(a) providing a database of individuals that comprises, for each individual, the genetic data parameters comprising hereditary parameters that play a role in tissue-typing for matching between donor and recipient and comprises genealogical data for a plurality of individuals including at least some of said individuals for whom the genetic data is provided in the database;

(b) determining a recipient tissue type (RTT) for the intended tissue recipient;

(c) searching the database for one or more individuals that have a degree of similarity to the RTT that satisfy predetermined criteria to thereby identify one or more pivot individuals; and

(d) searching for a target group of target individuals that includes the pivot individuals and individuals that are genetically related to the pivot individuals, and generating output data indicative of search results.

In some embodiments of the invention, the method further comprises searching for a matching donor among individuals in the target group.

In accordance with preferred embodiments of the invention, the genealogical data includes data of family trees, entered separately by different individuals, of the kind disclosed in WO 2007/083313. Also, preferably the data indicative of the family trees includes merged family trees. The merger of the database may be achieved in a manner as disclosed in WO 2008/053493. As noted above, the contents of both of these publications are incorporated herein by reference. Depending on the context, terms used herein have meanings as defined in said PCT applications.

The genealogical data, in accordance with this embodiment, is thus the product of separately entered family trees that are merged to one or more other family trees through one or more common individuals included in a separately entered family tree to yield one or more relationship webs of merged family trees. The database thus includes a relationship web of family trees, at times all family trees in the database that are merged to one another.

The computerized method according to the above preferred embodiment of the invention, thus comprises providing a database comprising genealogical data about individuals that comprise, for each individual, an individual-identifier data set (IDS) comprising data on family ties between the individual and one or more other, related individuals in the database. The IDS for at least some of the individuals in the database comprises an individual tissue-type data record (ITDR) on tissue type of the individual.

In some embodiments, the predetermined criteria correspond to a condition where the genetic data of the individual has a degree of similarity to the RTT above a defined threshold. In some other embodiments, the predetermined criteria correspond to a condition that the genetic data of the individual has genetic parameters that are predictive of a higher probability of finding a matching donor among genetically related individuals.

The combined database may be stored in a server utility of a computer network; or may be a distributed database stored in more than one computer, connectable to another computer(s) via a computer network.

The invention provides, by another of its aspects, a method for defining a target group of individuals enabling searching for a suitable donor for a candidate recipient. The method comprises:

providing a database of individuals that comprises, for each individual, the genetic data parameters comprising hereditary parameters that play a role in tissue-typing for matching between donor and recipient and comprises genealogical data for a plurality of individuals including at least some of said individuals for whom the genetic data is provided in the database;

for a candidate recipient with defined genetic data parameters, defining pivot individuals that (i) have genetic data parameters with a degree of similarity above a defined threshold to the corresponding genetic data parameters of the intended recipient, or (ii) have genetic parameters that are predictive of a higher probability of finding a matching donor among genetically related individuals; and

defining a target group of individuals for searching for a suitable tissue donor that includes the pivot individuals and genetically related individuals.

The target group of individuals is defined as including the pivot individuals and genetically related individuals.

Said defining of the target group may include searching for a suitable donor among the pivot individuals and where no matching donor is found, searching for a matching donor among the individuals related to the pivot individuals.

The invention also provides a system for identifying a suitable tissue donor for an intended tissue recipient, comprising:
a module for receiving input data including tissue-type data of a candidate recipient; and
a processing module configured and operable to be responsive to the input data for conducting a search in a database of individuals that comprises, for each individual, the genetic data parameters comprising hereditary parameters that play a role in tissue-typing for matching between donor and recipient and comprises genealogical data for a plurality of individuals including at least some of said individuals for whom the genetic data is provided in the database, said search comprising searching for pivot individuals that are individuals characterized by predetermined criteria of their related genetic data; defining a target group of potential suitable donors comprising said pivot individuals, and individuals genetically related thereto; and generating output data in the form of search results including data indicative of existence of the suitable tissue donor.

The method and system of the invention are particularly applicable for finding a bone marrow donor for an intended bone marrow recipient.

It should be noted that while the use of a database with merged family trees is preferred according to the invention, the invention may also be practiced on a database including a plurality of separate, non-merged, family trees. The database may be one created specifically for the purpose of matching a tissue, e.g. bone marrow, of a donor to a recipient or may be a genealogical database with the added feature of permitting genetic data/tissue-type searching. In the case of the use of a database according to WO 2007/083313, the genetic data constitutes part of the IDS.

The system of the invention typically operates over a computer network. The different functionalities may be achieved through server utilities, where one or more of such utilities contain the genealogical database with the genetic data records (e.g. distributed database), one or more including the processor utility, as well as a server-client software and/or hardware utility to enable server-client communication sessions for input of genetic data parameters relating to the transplantation candidate. The server utilities may be hardware or software server utility implementations, may be operative on a centralized server, may be utilities shared by two or more servers, or in any other relevant configuration. As will be appreciated, the invention is not limited by any hardware or software configuration of the server utility.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram of an example of a system of the present invention for identifying a suitable tissue donor for an intended recipient;

FIG. 2 is a schematic illustration of an example of a combined genetic and genealogical database constructed for the purposes of the present invention; and

FIG. 3 is a flow diagram of an example of a method of the present invention for identifying a suitable tissue donor for an intended recipient.

### DESCRIPTION OF A SPECIFIC EMBODIMENT

The following is a brief description of a specific and illustrative embodiment relating to locating a bone marrow donor for a candidate bone marrow recipient.

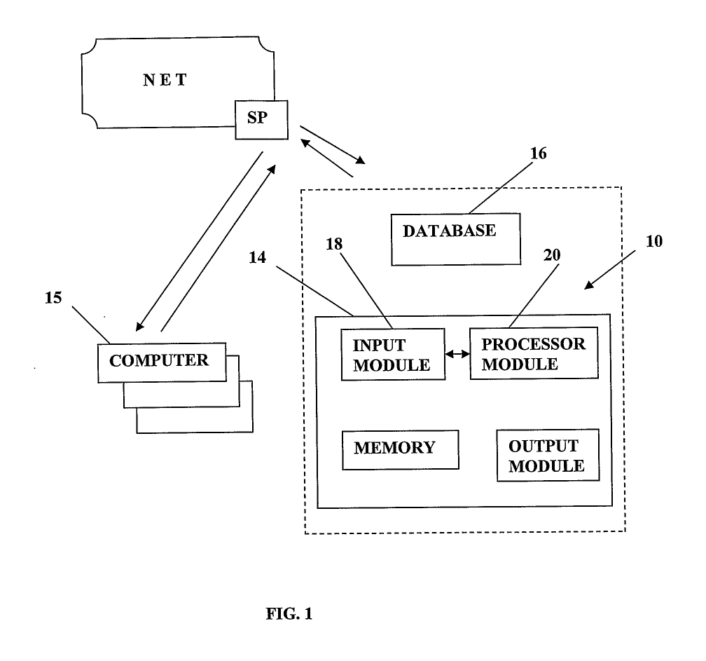

Referring to FIG. 1, there is schematically illustrated, by way of a block diagram, a system 10 configured and operable according to the invention for identifying a suitable tissue donor (e.g. bone marrow donor) for an intended recipient. System 10 is a computer system including inter alia such functional utilities (software and/or hardware) as data input utility, memory, processor, and data output (e.g. display). These utilities of system 10 may be distributed between multiple computers being in communication with one another, e.g. including communication via a computer network 12.

System 10 includes a server 14 accessible by other computers, generally at 15, via computer network 12. For example, server 14 may be a network server 14 or some of the functional utilities of the system server 14 may be incorporated in the network server, or may be connectable to the network via a server provider SP. Computer 15 may initiate communication with server 14 via a client-server communication session. It should be understood that a computer or computer system may utilize one or more personal computers or other communication devices such as phones.

System 10 includes a data inputting utility/module 18 and a processor module 20. Data inputting module 18 is associated (connectable to) with data input utilities (user interfaces) of computer systems 14 and 15. System 10 includes or is connectable to a database including genealogical database 16. Such a database may be stored in a memory of server utility 14 and/or in one or more other computers accessible from server utility 14 (i.e. may be a distributed database). Genealogical database 16 contains data about individuals that includes, for each individual, data on other individuals related to the individual through family relationships and the type of relationship. Also, according to the invention, database 16 includes or is related to another database including tissue-type data (bone marrow data) for at least some of the individuals in the genealogical database.

Tissue-type data of a candidate recipient can be inputted through an inputting module 18, which may or may not be a part of the server utility 14, and is associated with (connectable to) the data input utility of system 10. A processing module 20 is associated with (connectable to) the processor utility of the system 10 and is configured and operable for searching the database 16 for records relating to pivot individuals. As will be described more specifically further below, pivot individuals records are those which either have genetic or tissue-type data parameters with a degree of similarity above a defined threshold to the corresponding genetic data parameters of the intended recipient, or have genetic or tissue-type parameters that are predictive of a higher probability of finding a matching donor among genetically related individuals. The pivot individuals related to a certain candidate recipient define a target group of potential suitable donors comprising said pivot individuals and individuals genetically related thereto.

The genealogical database is configured as an Internet-implemented genealogical database, for example created in a manner described in WO 2007/083313, and contains data indicative of family trees and/or merged family trees for example merged in a manner described in WO 2008/053493.

More specifically, a genealogical data of individuals includes, for each individual, an individual-identifier data set (IDS). The IDS includes data on family ties between the individual and one or more other, related individuals in the database. The genetic or tissue-type data included in or related to the genealogical data includes or assigns for the IDS for at least some of the individuals an individual tissue-type data record (ITDR) on tissue type(s) of the individual.

Such a combined genealogical and tissue-type database 16 and data input utility 18 are configured to provide suitable entry fields permitting users to input tissue-type and other genetic data into the system. Thus, as a result, some of the IDSs in the combined database that is thus created include also (or are related to) genetic data. The genetic data may, for example, include MHC data. The inputting module allows a user, being or belonging to a candidate recipient, to enter a request for a donor, or generally a request for a search for genealogical possible matches based on his (user's) genetic or tissue-type data. Also, the inputting utility allows any user to subscribe to the database and allows a user being a subscriber to update his related records in the database. Processor utility 20 is configured (preprogrammed) to identify a user's request and to access the database and run a suitable algorithm on the contents of the database, e.g. search the database for one or more ITDRs that have a degree of similarity to the recipient tissue type (RTT) to thereby identify one or more pivot individuals, for defining a target group of potential suitable tissue donors, updating the data records, etc.

It should be noted that rather than or in addition to user-inputted genetic data, genetic data may also be imported from genetic data databases, e.g. such that exist in bone marrow banks and databases, cord-blood banks, etc. The imported genetic data can then be merged with the individual-related data to be included as part of the IDSs.

The genetic data is typically not data intended to be widely publicized over the network. However, it is nonetheless data that may be searched by an appropriate processor utility. If needed, a suitable security or data protective algorithm may be applied in response to the user's request. For example, the request is automatically conveyed to a computer system of an authorized entity having access or permitting access to the users' related data records.

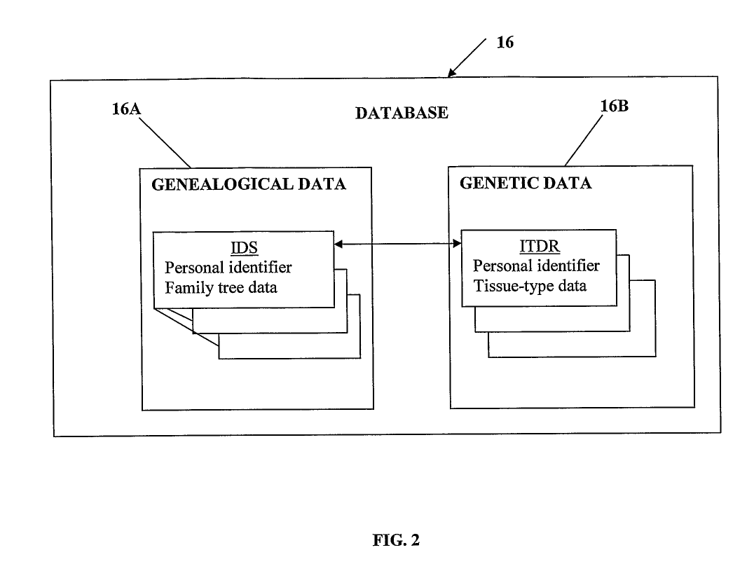

Reference is made to FIG. 2 exemplifying a configuration of database 16 constructed according to the invention. In this example, database 16 includes a genealogical database part 16A, a genetic or tissue-type database 16B, and data indicative of a relation between data records in these two databases 16A and 16B (e.g. on the basis of indices). Genealogical database part 16A includes a plurality of data records, generally at 17, each including various data fields including IDS and possibly other data, and data indicative of a relation (connection lines) 19 between different IDSs. IDS includes inter alia unique data, being a personal identifier, enabling identification of a corresponding individual. Genetic or tissue-type database 16B includes various data records 22, each including a personal identifier relating to (e.g. matching or being identical to) the personal identifier of the IDS of the data record of the same individual in the genealogical database part 16A and also including various genetic data of said individual (termed here ITDR). The personal identifiers in the data records of the genealogical and genetic database parts 16A and 16B constitute data indicative of a relation between the records in the databases. Optionally, genetic database 16B may also include correlation data for establishing genetic connections between different individuals.

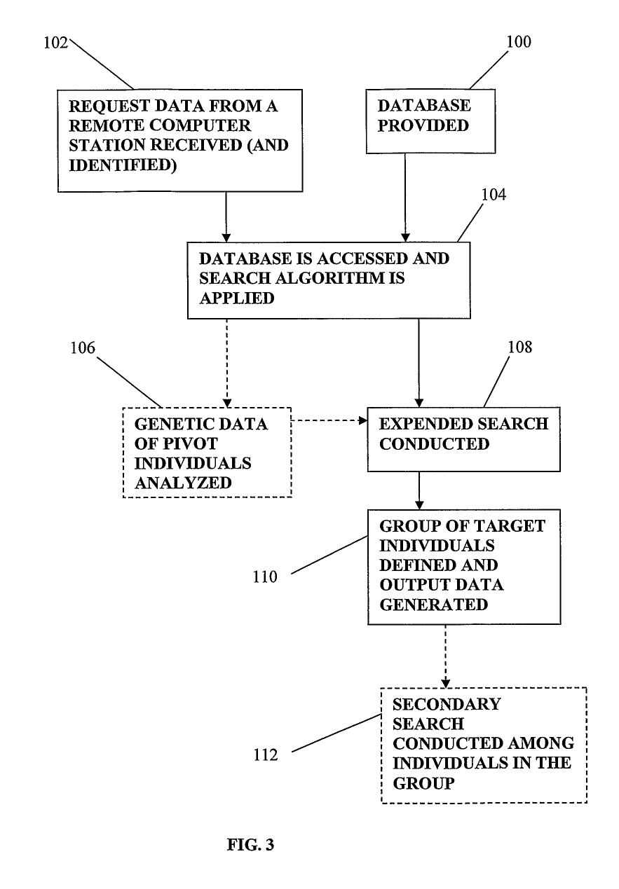

Reference is now made to FIG. 3 showing a flow diagram of an example of a method of the present invention for defining a target group of target individuals for searching for a suitable donor to a candidate recipient.

A database is provided (step 100) including data about multiple individuals and being configured as described above, namely including for each individual the genetic or tissue-type data parameters (enabling to determine a match between donor and recipient). Also, the database includes or allows access to genealogical data of multiple individuals including at least part of the individuals of the genetic database. In other words, the personal identifiers in the genealogical and genetic databases at least partially overlap. The genealogical data contains data relating to a specific individual and other individuals related to said individual through family relationships and the type of relationship.

A computer system receives request data from a remote computer station (step 102). The system then operates to identify the request data For example, the request data is identified as including recipient tissue type (RTT) data. Such genetic data parameters of a candidate tissue type (bone marrow transplant) may be determined and inputted into the system processor and possibly also stored in the memory (e.g. for further statistical research). The user might have input the request through a dedicated console, a web entry page, etc.

The system processor utility (e.g. operated on a system network server(s)) makes access to the database and runs a search algorithm for determining pivot individuals (step 104). As described above, these are individuals with corresponding genetic data parameters with a similarity above a defined threshold or minimum to the corresponding genetic data parameters of the intended recipient. The threshold may be automatically set by the system or may be specifically set by a healthcare professional (constituting an authorized entity mentioned above) that initiates the search. For example, where the genetic data parameters consist of MHC antigens, a threshold may be defined as a number of identical MHC antigens that will qualify an individual as a pivot individual. Alternatively or additionally, pivot individuals are those who have genetic parameters that are predictive (e.g. statistically) of a higher probability of finding a matching donor among genetically related individuals.

Various search strategies may be adopted. There are many bioinformatics and other algorithms that are used in research or in diagnostic laboratories and a person skilled in the art will be able to choose the appropriate algorithm to be implemented in the system for optimal search for pivot individuals.

In this connection, it should be noted that criteria for defining an individual as a pivot individual may or may not be the same criteria as that of an optional donor. Alternatively or additionally, the case may be such that one or more of the pivot individuals includes data indicative of a possibility of existence of a suitable donor in their family members or relating family trees, which cannot be found directly in the genetic database, for example because of lack of their genetic data or a part of such data relating to a specific request.

Thus, the system processor might operate to analyze the pivot individuals' genetic data (optional step 106) to determine whether a suitable donor can be found there or a further search is needed, or automatically attend to expanding the search (step 108). For example, depending on the search strategy, pivot individuals may at times be qualified as such, even if they themselves do not meet the threshold requirement, if the genetic data parameters of the individual and that of related individuals jointly increase the probability that one of their genetically related individuals may be a suitable donor. For example, two married individuals may be qualified as pivot individuals on the basis that their combined parameters may have an inheritance pattern such that their children may prove to be suitable donors. Furthermore, two or more individuals that are genetically related can be qualified as pivot individuals if their combined genetic data parameters render their genetically related individuals as a target group with a relatively high likelihood of being a suitable tissue donor.

It is to be noted that pivot individuals may include active users of the genealogical database as well as others for which genetic data is available. For example, a deceased individual for whom genetic data is available may nonetheless be qualified as a pivot individual since genetically related individuals may prove to be suitable donors.

At times, a good match is found among the pivot individuals and no further search is needed. However, in most cases a further search among the genetically related target individuals may be needed. Thus, an expanded search is applied to the genealogical database part and is aimed at defining a group of target individuals for searching for a suitable tissue donor (step 110). The target individuals may, by some embodiments, be defined to include all individuals with a degree of separation from the pivot individuals that is less than a defined distance in the family tree. For example, where the maximal separation is set at two, included in the target individuals will be such with a direct link, including parents and children, as well as such with a double separation including siblings, grandchildren and grandparents. Alternatively, the target individuals may be context-dependent. For example, where the genetic data parameters closely match those of the candidate recipient, it may be sufficient to search among a smaller circle of individuals. Where the degree of matching is lower, the search may need to be widened to include individuals with a higher degree of separation.

Also, based on various hereditary considerations, the target individuals may be defined among the genetically related individuals to include those where the chance of finding a matching donor is highest. For example, in the case of two parents that are qualified as pivot individuals, the target individuals may include their children only; or a target individual may be a sibling to a pivot individual.

Based on the degree of match between the candidate recipient and the pivot individuals as well as on various genetic, bioinformatic, population genetics and other considerations, target individuals may be ascribed with a probability that they will prove to be suitable donors. In addition or in the alternative, the probability may be ascribed to an entire domain of target individuals (a domain being a group of related individuals that are qualified as target individuals). Thus, optionally, a result of the primary searches in the genetic and genealogical databases results in a group of target individuals, and by some embodiments of the invention, a secondary search among the target individuals may be prioritized based on the above-described probabilities (step 112).

Then, the eventual output data is provided (step 114) including a list of target individuals where the probability of finding a suitable donor is higher than in the general population. Additionally, each individual in such list may be coupled by a matching probability to allow an efficient secondary search.

Once identified, corresponding output data is generated by the processor and the target individuals may receive a notification requesting them to either provide their relevant genetic data parameters or to undergo the needed laboratory tests to examine whether they are suitable donors.

1. A method for identifying a suitable tissue donor for an intended tissue recipient, the method comprising:
(a) providing a database of individuals that comprises, for each individual, the genetic data parameters comprising hereditary parameters that play a role in tissue-typing for matching between donor and recipient and comprises genealogical data for a plurality of individuals including at least some of said individuals for whom the genetic data is provided in the database;
(b) determining a recipient tissue type (RTT) for the intended tissue recipient;
(c) searching the database for one or more individuals that have a degree of similarity to the RTT that satisfy predetermined criteria to thereby identify one or more pivot individuals; and
(d) searching for a target group of target individuals that includes the pivot individuals and individuals that are genetically related to the pivot individuals, and generating output data indicative of search results.

2. A method according to claim 1, wherein the genetic data parameters comprise one or more individual tissue-type data records (ITDRs).

3. A method according to claim 1, wherein the genealogical data comprises, for each individual, an individual-identifier data set (IDS) comprising data on family ties between the individual and one or more other, related individuals in the database; the IDS for at least some of the individuals in the database having a related individual tissue-type data record (ITDR) on tissue type of the individual.

4. A method according to claim 1, wherein said predetermined criteria corresponds to a condition that the genetic data of the individual has a degree of similarity to the RTT above a defined threshold.

5. A method according to claim 1, wherein said predetermined criteria corresponds to a condition that the genetic data of the individual has genetic parameters that are predictive of a higher probability of finding a matching donor among genetically related individuals.

6. A method according to claim 1, wherein the target group of individuals is defined as including the pivot individuals and genetically related individuals.

7. A method according to claim 1, comprising searching for a matching donor among said target group.

8. A method according to claim 1, wherein step (d) comprises searching for a suitable donor among the pivot individuals and where no matching donor is found, searching for a matching donor among the individuals related to the pivot individuals.

9. A method according to claim 1, for finding a bone marrow donor for an intended bone marrow recipient.

10. A method according to claim 1, wherein said genealogical data comprises data on family trees entered by different individuals.

11. A method according to claim 1, wherein the genealogical data comprises one or more separately entered family trees that are merged to one or more other family trees through one or more common individuals included in a separately entered family tree to yield one or more relationship webs of merged family trees.

12. A method according to claim 11, wherein the genealogical data comprises a relationship web of all family trees merged to one another.

13. A method according to claim 1, wherein the database is stored in a server utility of a computer network.

14. A method according to claim 1, wherein the database is a distributed database stored in at least two computers connectable to one another via a computer network.

15. A method for defining a target group of individuals enabling searching for a suitable donor for a candidate recipient, the method comprising:
providing a database of individuals that comprises, for each individual, the genetic data parameters comprising hereditary parameters that play a role in tissue-typing for matching between donor and recipient and comprises genealogical data for a plurality of individuals including at least some of said individuals for whom the genetic data is provided in the database;
for a candidate recipient with defined genetic data parameters, defining pivot individuals that (i) have genetic data parameters with a degree of similarity above a defined threshold to the corresponding genetic data parameters of the intended recipient, or (ii) have genetic parameters that are predictive of a higher probability of finding a matching donor among genetically related individuals; and
defining a target group of individuals for searching for a suitable tissue donor that includes the pivot individuals and genetically related individuals.

16. A method according to claim 15, comprising searching for a matching donor among said target group.

17. A system for carrying out the method of claim 1 for identifying a suitable tissue donor for an intended tissue recipient.

18. A system for identifying a suitable tissue donor for an intended tissue recipient, comprising:
a module for receiving input data including tissue-type data of a candidate recipient; and
a processing module configured and operable to be responsive to the input data for conducting a search in a database of individuals that comprises, for each individual, the genetic data parameters comprising hereditary parameters that play a role in tissue-typing for matching between donor and recipient and comprises genealogical data for a plurality of individuals including at least some of said individuals for whom the genetic data is provided in the database, said search comprising searching for pivot individuals that are individuals characterized by predetermined criteria of their related genetic data; defining a target group of potential suitable donors comprising said pivot individuals and individuals genetically related thereto; and generating output data in the form of search results including data indicative of existence of the suitable tissue donor.

19. A system according to claim 18, wherein said predetermined criteria correspond to a certain condition of the hereditary parameters of the individuals.

20. A system according to claim 18, wherein said processing module is preprogrammed to identify said predetermined criteria as existence of one of the following conditions:
(i) the pivot individuals have genetic data parameters with a degree of similarity above a defined threshold to the corresponding genetic data parameters of the intended recipient, and
(ii) have genetic parameters that are predictive of a higher probability of finding a matching donor among genetically related individuals and for defining a target group of potential suitable donors comprising said pivot individuals and individuals genetically related thereto.

21. A system according to claim 20, wherein the genetic data parameters comprise one or more individual tissue-type data records (ITDRs).

22. A system according to claim 20, wherein the genealogical data comprises, for each individual, an individual-identifier data set (IDS) comprising data on family ties between the individual and one or more other, related individuals in the database; the IDS for at least some of the individuals in the database having a related individual tissue-type data record (ITDR) on tissue type of the individual.

23. A system according to claim 20, wherein said predetermined criteria correspond to a condition that the genetic data of the individual has a degree of similarity to the RTT above a defined threshold.

24. A system according to claim 20, wherein said genealogical data comprises data on family trees entered by different individuals.

25. A system according to claim 24, wherein the genealogical data comprises one or more separately entered family trees that are merged to one or more other family trees through one or more common individuals included in a separately entered family tree to yield one or more relationship webs of merged family trees.

26. A system according to claim 25, wherein the genealogical data comprises a relationship web of all family trees merged to one another.

27. A system according to claim 20, comprising a memory utility for storing said database.

28. A system according to claim 20, being a server utility of a computer network.

29. A system according to claim 20, being configured and operable for accessing at least a part of said database from a remote memory via a computer network.

30. A system for identifying a suitable tissue donor for a needing tissue recipient, the method comprising:
a database of individuals that comprises, for each individual, data comprising an individual-identifier data set (IDS comprising data on family ties between the individual and one or more other, related individuals in the database, the IDS for at least some of the individuals in the database comprising an individual tissue-type data record (ITDR) on tissue type of the individual;
a module for inputting data on the recipient tissue type (RTT) of the intended tissue recipient;
a processor for searching the database for one or more ITDRs that have a degree of similarity to the RTT that is above a defined threshold to thereby identify one or more pivot individuals and for defining a target group of potential suitable tissue donors including the pivot individuals and individuals related thereto.

31. A system according to claim 30, for finding a bone marrow donor for a candidate bone marrow recipient.

32. A system according to claim 30, comprising:
a server utility capable of accessing said database of individuals that comprises, for each individual, the genealogical data comprising an individual-identifier data set (IDS) comprising data on family ties between the individual and one or more other, related individuals in the database, and the genetic data comprising an individual genetic data record (GDR) relating to the IDS for at least some of the individuals;
a user interface utility for inputting data on the recipient tissue type (RTT) of the intended tissue recipient;
a processor utility configured and operable for searching the database for one or more GDRs that have a degree of similarity to the RTT that is above a defined threshold to thereby identify one or more pivot individuals and for defining a group of potential tissue donors including the pivot individuals and individuals related thereto.

33. A server system accessible by remote computers via a computer network, the server system comprising:
a memory for storing a database of individuals that comprises, for each individual, the genetic data parameters comprising hereditary parameters that play a role in tissue-typing for matching between donor and recipient and comprises genealogical data for a plurality of individuals including at least some of said individuals for whom the genetic data is provided in the database;
a data inputting module being responsive to a request received from the remote computer; and
a processor configured and operable for identifying the received request to search in said database for pivot individuals that are individuals characterized by predetermined criteria of their related genetic data, defining a target group of potential suitable donors comprising said pivot individuals and individuals genetically related thereto, and generating output data in the form of search results including data indicative of the existence of the suitable tissue donor.

34. A system according to claim 33, wherein the computer network is the Internet.
